(19) United States
(12) Patent Application Publication
(10) Pub. No.: US 2026/0235917 A1
(43) Pub. Date: Aug. 13, 2026

(54) DISPLAY DEVICE

(71) Applicant: Japan Display Inc., Tokyo (JP)

(72) Inventors: Kasumi HASE, Tokyo (JP); Koichi IGETA, Tokyo (JP); Shinichiro OKA, Tokyo (JP)

(73) Assignee: Japan Display Inc., Tokyo (JP)

(21) Appl. No.: 19/530,646

(22) Filed: Feb. 5, 2026

(30) Foreign Application Priority Data
Feb. 12, 2025 (JP) 2025-020717

(51) Int. Cl. G02F 1/137; G02F 1/1335; H04N 13/32

(52) U.S. Cl. CPC G02F 1/13718; G02F 1/133512; G02F 1/133541; G02F 1/133553; H04N 13/32

(57) ABSTRACT

According to one embodiment, a display device includes a transparent substrate having a first main surface and a second main surface, a display module configured to emit a first display light and a second display light, a first optical element, and a second optical element. A first liquid crystal layer of the second optical element reflects the first display light reflected by a first liquid crystal layer of the first optical element, toward a first observation position facing the first main surface. A second liquid crystal layer of the second optical element reflects the second display light reflected by a second liquid crystal layer of the first optical element, toward a second observation position facing the second main surface.

### CROSS-REFERENCE TO RELATED APPLICATIONS

This application is based upon and claims the benefit of priority from Japanese Patent Application No. 2025-020717, filed Feb. 12, 2025, the entire contents of which are incorporated herein by reference.

### FIELD

Embodiments described herein relate generally to a display device.

### BACKGROUND

Recently, various types of optical elements using a holographic optical element (which may be hereinafter simply referred to as an HOE) which diffracts display light emitted from a display element and a light guide member have been considered. For example, a technique which provides a holographic diffractive optical element on each surface of the light guide member is known. The HOE provided on one surface of the light guide member diffracts display light so as to be totally reflected by the light guide member. The HOE provided on the other surface of the light guide member diffracts display light which propagates inside the light guide member so as to be emitted to the outside.

In contrast, a display device is demanded that enables observation of images from both observation positions across the display device. For example, in a display device that applies polymer-dispersed liquid crystal, when an image is displayed, an image observed from one observation position is inverted relative to an image observed from the other observation position. When the image includes characters, the characters are readable at one observation position but difficult to read at the other observation position.

### BRIEF DESCRIPTION OF THE DRAWINGS

FIG. 1 is a view showing a configuration example of a display device DSP.

FIG. 2 is a cross-sectional view for describing an example of a cholesteric liquid crystal CL1 contained in a liquid crystal layer 11 and a cholesteric liquid crystal CL2 contained in a liquid crystal layer 12 shown in FIG. 1.

FIG. 3 is a plan view schematically showing the liquid crystal layer 11 and the liquid crystal layer 12 shown in FIG. 2.

FIG. 4 is a cross-sectional view for describing an example of the cholesteric liquid crystal CL1 contained in a liquid crystal layer 21 and a cholesteric liquid crystal CL2 contained in a liquid crystal layer 22 shown in FIG. 1.

FIG. 5 is a plan view schematically showing the liquid crystal layer 21 and the liquid crystal layer 22 shown in FIG. 4.

FIG. 6 is a perspective view for describing a display module DM shown in FIG. 1.

FIG. 7 is a perspective view of the display device DSP.

FIG. 8 is a view for describing a usage of the display device DSP.

FIG. 9 is a view for describing another usage of the display device DSP.

FIG. 10 is a view showing another configuration example of the display device DSP.

FIG. 11 is a view showing another configuration example of the display device DSP.

FIG. 12 is a view for describing a first optical element 10 of the display device DSP shown in FIG. 11.

FIG. 13 is a view for describing a second optical element 20 of the display device DSP shown in FIG. 11.

FIG. 14 is a view showing another configuration example of the display device DSP.

FIG. 15 is a view showing another configuration example of the display device DSP.

FIG. 16 is a view showing another configuration example of the display device DSP.

FIG. 17 is a view for explaining the display module DM shown in FIG. 16.

FIG. 18 is a view showing another configuration example of the display device DSP.

FIG. 19 is a view showing another configuration example of the display device DSP.

### DETAILED DESCRIPTION

In general, according to one embodiment, a display device includes a transparent substrate having a first main surface and a second main surface on a side opposite to the first main surface, a display module facing the first main surface and configured to emit a first display light and a second display light toward the transparent substrate, a first optical element facing the display module via the transparent substrate, provided on the second main surface, and configured to reflect the first display light and the second display light each passed through the transparent substrate, and a second optical element spaced apart from the first optical element, provided on the second main surface, and configured to reflect the first display light and the second display light each propagated inside the transparent substrate. The first display light and the second display light are circularly polarized in opposite directions. Each of the first optical element and the second optical element includes a first liquid crystal layer containing a first cholesteric liquid crystal and a second liquid crystal layer overlapping the first liquid crystal layer and containing a second cholesteric liquid crystal twisted in an opposite direction to the first cholesteric liquid crystal. The first liquid crystal layer of the second optical element is configured to reflect the first display light reflected by the first liquid crystal layer of the first optical element, toward a first observation position facing the first main surface. The second liquid crystal layer of the second optical element is configured to reflect the second display light reflected by the second liquid crystal layer of the first optical element, toward a second observation position facing the second main surface.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plane defined by the first direction X and the second direction Y is referred to as an X-Y plane. A plane defined by the second direction Y and the third direction Z is referred to as a Y-Z plane. A plane defined by the first direction X and the third direction Z is referred to as an X-Z plane. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

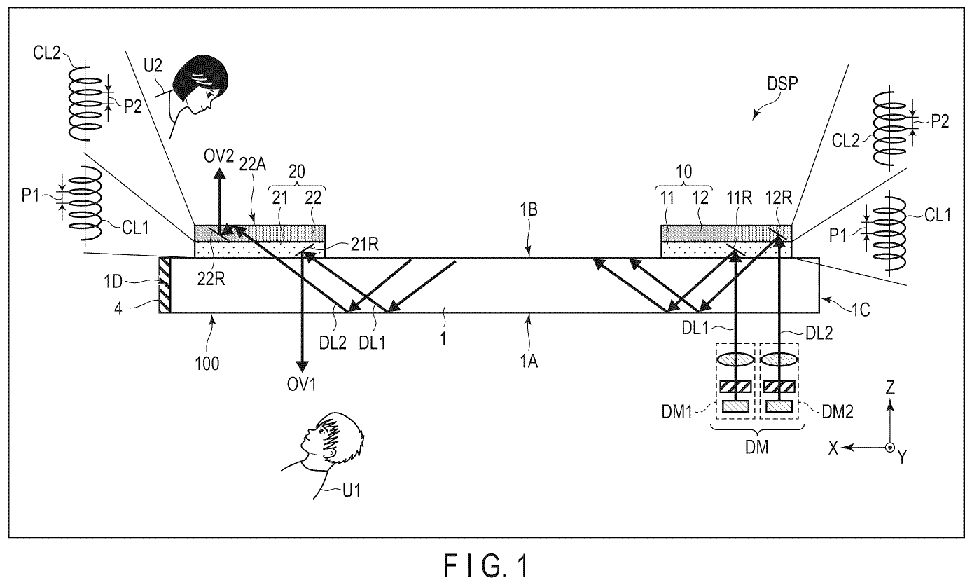

FIG. 1 is a view showing a configuration example of a display device DSP.

The display device DSP comprises a display module DM and a liquid crystal optical element 100. The liquid crystal optical element 100 comprises a transparent substrate 1, a first optical element 10, and a second optical element 20.

For example, the transparent substrate 1 is a glass substrate, but may also be a resin substrate. The transparent substrate 1 is formed into a flat plate shape and has a first main surface 1A and a second main surface 1B on a side opposite to the first main surface 1A. The first main surface 1A and the second main surface 1B are substantially parallel to the X-Y plane and face each other in the third direction Z. Further, the transparent substrate 1 has a first side surface 1C and a second side surface 1D on the side opposite to the first side surface 1C. The first side surface 1C and the second side surface 1D are substantially parallel to the Y-Z plane and face each other in the first direction X. The third direction Z corresponds to the thickness direction of the transparent substrate 1.

The display module DM faces the first main surface 1A in the third direction Z, and is configured to emit first display light DL1 and second display light DL2 toward the transparent substrate 1. Details of the display module DM will be described later. In the illustrated configuration example, the display module DM includes a first display module DM1 and a second display module DM2. The second display module DM2 is spaced apart from the first display module DM1. For example, the first display module DM1 and the second display module DM2 are arranged side by side along the first direction X. The first display module DM1 and the second display module DM2 may be arranged in the second direction Y or a direction other than the first direction X and the second direction Y.

The first display module DM1 is configured to emit the first display light DL1 along the third direction Z. The second display module DM2 is configured to emit the second display light DL2 along the third direction Z. The first display light DL1 and the second display light DL2 are circularly polarized in opposite directions and are collimated.

The first optical element 10 faces the display module DM across the transparent substrate 1 in the third direction Z and is provided on the second main surface 1B. That is, the transparent substrate 1 is located between the display module DM and the first optical element 10 in the third direction Z. In one example, the first optical element 10 is bonded to the transparent substrate 1. This first optical element 10 is configured to reflect the first display light DL1 and the second display light DL2 passed through the transparent substrate 1. In the first optical element 10, angles at which the first display light DL1 and the second display light DL2 are reflected are set such that each of the first display light DL1 and the second display light DL2 undergoes total reflection inside the transparent substrate 1.

The second optical element 20 is spaced apart from the first optical element 10 and is provided on the second main surface 1B. In one example, the second optical element 20 is bonded to the transparent substrate 1. The second optical element 20 is configured to reflect the first display light DL1 and the second display light DL2 propagated inside the transparent substrate 1.

The first optical element 10 and the second optical element 20 are arranged at an interval from each other in the first direction X. In the transparent substrate 1, the first side surface 1C is located on the side close to the first optical element 10. The second side surface 1D is located on the side close to the second optical element 20.

For example, each of the first optical element 10 and the second optical element 20 may be formed of a liquid crystal layer containing cholesteric liquid crystal.

The first optical element 10 comprises a liquid crystal layer 11 and a liquid crystal layer 12. The liquid crystal layer 11 is provided on the second main surface 1B. The liquid crystal layer 12 overlaps the liquid crystal layer 11 in the third direction Z. That is, the first optical element 10 is configured as a stacked layer body of a plurality of liquid crystal layers.

The second optical element 20 comprises a liquid crystal layer 21 and a liquid crystal layer 22. The liquid crystal layer 21 is provided on the second main surface 1B and is spaced apart from the liquid crystal layer 11. The liquid crystal layer 22 overlaps the liquid crystal layer 21 in the third direction Z. That is, the second optical element 20 is configured as a stacked layer body of a plurality of liquid crystal layers. The stacking order of each of the plurality of liquid crystal layers in the first optical element 10 and the second optical element 20 is not limited to the illustrated example.

Each of the liquid crystal layer 11 and the liquid crystal layer 21 contains the cholesteric liquid crystals CL1 as schematically shown in the enlarged view. Each of the cholesteric liquid crystals CL1 of the liquid crystal layer 11 and the liquid crystal layer 21 has the same twist direction and has the same helical pitch P1 along third direction Z. The helical pitch indicates one period of the helix (in other words, the distance along the third direction Z required for a 360-degree twist of the liquid crystal molecule).

Each of the liquid crystal layer 12 and the liquid crystal layer 22 contains the cholesteric liquid crystals CL2 as schematically shown in the enlarged view. Each of the cholesteric liquid crystals CL2 of the liquid crystal layer 12 and the liquid crystal layer 22 has the same twist direction and has the same helical pitch P2 along third direction Z. The twist direction of the cholesteric liquid crystal CL2 is opposite to that of the cholesteric liquid crystal CL1. The helical pitch P2 is equivalent to the helical pitch P1.

Each of the liquid crystal layer 11, the liquid crystal layer 12, the liquid crystal layer 21, and the liquid crystal layer 22 is configured to reflect, of incident light, circularly polarized light in a selective reflection range determined based on the helical pitch P and the refractive anisotropy Δn of the liquid crystal film. For example, the selective reflection ranges of the liquid crystal layer 11, the liquid crystal layer 12, the liquid crystal layer 21, and the liquid crystal layer 22 have the same wavelength ranges.

In the first optical element 10, the liquid crystal layer 11 has a reflective surface 11R reflecting circularly polarized light corresponding to the twist direction of the cholesteric liquid crystal CL1 in the selective reflection range. The liquid crystal layer 12 has a reflective surface 12R reflecting circularly polarized light corresponding to the twist direction of the cholesteric liquid crystal CL2 in the selective reflection range. Each of the reflective surfaces 11R and 12R inclines with respect to the X-Y plane. In this specification, circularly polarized light may be strict circularly polarized light or may be circularly polarized light which approximates elliptically polarized light.

In the second optical element 20, the liquid crystal layer 21 has a reflective surface 21R reflecting circularly polarized light corresponding to the twist direction of the cholesteric liquid crystal CL1 in the selective reflection range. The liquid crystal layer 22 has a reflective surface 22R reflecting circularly polarized light corresponding to the twist direction of the cholesteric liquid crystal CL2 in the selective reflection range. Each of the reflective surfaces 21R and 22R inclines with respect to the X-Y plane.

As described above, the cholesteric liquid crystal CL1 included in the liquid crystal layer 11 and the cholesteric liquid crystals CL1 included in the liquid crystal layer 21 have the same twist direction and have the same helical pitch P1. Thus, the liquid crystal layer 11 and the liquid crystal layer 21 can reflect circularly polarized light of the same wavelength range and the same twist direction.

Thus, the liquid crystal layer 21 reflects the first display light DL1, which is circularly polarized light reflected by the liquid crystal layer 11. The reflective surface 21R is inclined such that it reflects the first display light DL1 toward a first observation position OV1 facing the first main surface 1A.

As described above, the cholesteric liquid crystal CL2 included in the liquid crystal layer 12 and the cholesteric liquid crystals CL2 included in the liquid crystal layer 22 have the same twist direction and have the same helical pitch P2. Thus, the liquid crystal layer 12 and the liquid crystal layer 22 can reflect circularly polarized light of the same wavelength range and the same twist direction.

Thus, the liquid crystal layer 22 reflects the second display light DL2, which is circularly polarized light reflected by the liquid crystal layer 12. The reflective surface 22R is inclined such that it reflects the second display light DL2 toward a second observation position OV2 facing the second main surface 1B. Circularly polarized light reflected by the liquid crystal layer 12 and the liquid crystal layer 22 are circularly polarized in opposite directions to the circularly polarized light reflected by the liquid crystal layer 11 and the liquid crystal layer 21.

In the transparent substrate 1, substantially the entire area of the first main surface 1A is exposed to air and forms an interface at which the first display light DL1 and the second display light DL2 could undergo total reflection. The area of the second main surface 1B between the first optical element 10 and the second optical element 20 is exposed to air and forms an interface at which the first display light DL1 and the second display light DL2 could undergo total reflection. Furthermore, the main surface 22A of the liquid crystal layer 22 on the side opposite to the liquid crystal layer 21 is exposed to air and forms an interface at which the second display light DL2 could undergo total reflection.

Such interfaces, at which total reflection may occur, may be covered with a thin film having a refractive index lower than that of the transparent substrate 1.

In the illustrated example, the display device DSP further comprises a light absorber 4 covering the second side surface 1D. The light absorber 4 is formed of an organic insulating material, an inorganic insulating material, a metal material, or the like. The first side surface 1C is not covered with the light absorber 4. The entire side surfaces of the transparent substrate 1 may be covered with the light absorber 4. Alternatively, instead of the side surface of the transparent substrate 1 being covered with the light absorber 4, at least the second side surface 1D may have frosted finish.

The following will describe light propagation in the display device DSP.

The first display module DM1 emits the first display light DL1, which is the first circularly polarized light (for example, right-handed circularly polarized light). The second display module DM2 emits the second display light DL2, which is the second circularly polarized light (for example, left-handed circularly polarized light) having a rotation direction opposite to the first circularly polarized light.

The liquid crystal layer 11 and the liquid crystal layer 21 are configured to reflect the first circularly polarized light (the right-handed circularly polarized light). The liquid crystal layer 12 and the liquid crystal layer 22 are configured to reflect the second circularly polarized light (the left-handed circularly polarized light).

The first display light DL1 passes through the transparent substrate 1 and is reflected by the reflective surface 11R in the liquid crystal layer 11.

The second display light DL2 passes through the transparent substrate 1 and the liquid crystal layer 11 and is reflected by the reflective surface 12R in the liquid crystal layer 12.

Each of the first display light DL1 and the second display light DL2 propagates along the first direction X while undergoing total reflection at the first main surface 1A and the second main surface 1B of the transparent substrate 1.

The first display light DL1 propagated inside the transparent substrate 1 is reflected by the reflective surface 21R in the liquid crystal layer 21. The reflected first display light DL1 passes through the transparent substrate 1 and is observed by a user U1 at the first observation position OV1.

The second display light DL2 propagated inside the transparent substrate 1 passes through the liquid crystal layer 21, undergoes total reflection at the main surface 22A of the liquid crystal layer 22, and is then reflected by the reflective surface 22R. The reflected second display light DL2 is observed by a user U2 at the second observation position OV2.

In one example, in the liquid crystal layer 21, the angle at which the first display light DL1 is reflected is set such that the first display light DL1 is emitted from the first main surface 1A at an angle substantially perpendicular to the first main surface 1A. Further, in the liquid crystal layer 22, the angle at which the second display light DL2 is reflected is set such that the second display light DL2 is emitted from the second main surface 1B at an angle substantially perpendicular to the second main surface 1B.

The reflections at the reflective surface 11R of the liquid crystal layer 11, the reflective surface 12R of the liquid crystal layer 12, the reflective surface 21R of the liquid crystal layer 21, and the reflective surface 22R of the liquid crystal layer 22 involve diffraction inside the respective liquid crystal layers.

Accordingly, the display device DSP can display images to the user U1 and the user U2 who face each other across the display device DSP. That is, the user U1 at the first observation position OV1 can observe the first image generated by the first display light DL1. That is, the user U2 at the second observation position OV2 can observe the second image generated by the second display light DL2.

In this observation, the first display light DL1 is barely emitted toward the second observation position OV2 in the second optical element 20. Similarly, the second display light DL2 is barely emitted toward the first observation position OV1 in the second optical element 20. Further, even if the first display light DL1 or the second display light DL2 reaches the second side surface 1D, the first light DL1 and the second display light DL2 are mostly absorbed by the light absorber 4.

Thus, at the first observation position OV1, the second display light DL2 does not mix with the first display light DL1. Thus, the first image corresponding to the first display light DL1 can be observed with high clarity at the first observation position OV1. Similarly, at the second observation position OV2, the first display light DL1 does not mix with the second display light DL2. Thus, the second image corresponding to the second display light DL2 can be observed with high clarity at the second observation position OV2.

The helical pitch P1 of the cholesteric liquid crystal CL1 is set according to the wavelength range of the first display light DL1. The helical pitch P2 of the cholesteric liquid crystal CL2 is set according to the wavelength range of the second display light DL2. In the illustrated configuration example, the first display light DL1 and the second display light DL2 have the same wavelength range, and the helical pitch P1 is equivalent to the helical pitch P2. However, the wavelength ranges of the first display light DL1 and the second display light DL2 may differ from each other. In such cases, the helical pitch P1 differs from the helical pitch P2.

The following will describe the first optical element 10 and the second optical element 20.

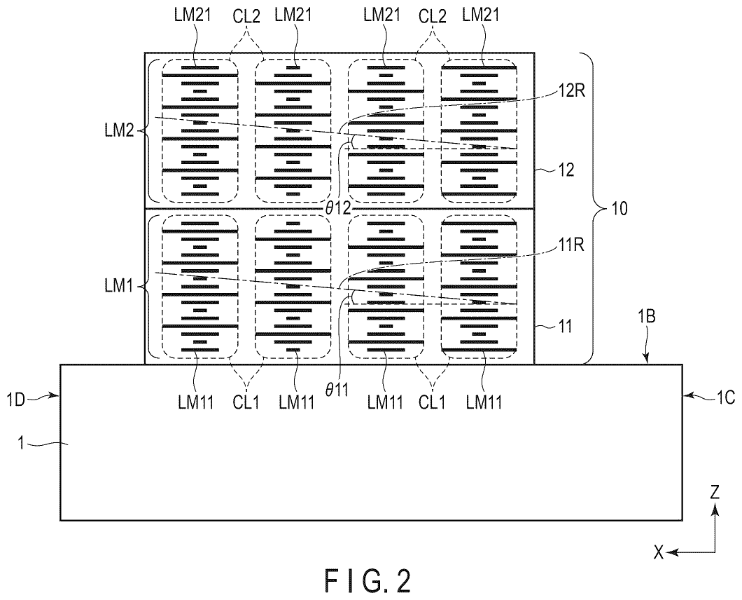

FIG. 2 is a cross-sectional view for describing an example of the cholesteric liquid crystal CL1 contained in the liquid crystal layer 11 and the cholesteric liquid crystal CL2 contained in the liquid crystal layer 12 shown in FIG. 1.

With respect to one of the cholesteric liquid crystals CL1 surrounded by broken lines in the liquid crystal layer 11, the cholesteric liquid crystal CL1 consists of a plurality of liquid crystal molecules LM1 helically stacked along the third direction Z while twisting. To simplify the illustration, FIG. 2 shows one liquid crystal molecule LM1 among the liquid crystal molecules located in the same plane parallel to an X-Y plane as the liquid crystal molecules LM1 constituting each cholesteric liquid crystal CL1. The alignment direction of each liquid crystal molecule LM1 shown in the figure corresponds to the average alignment direction of the liquid crystal molecules located in the same plane.

In the illustrated X-Z cross section, the alignment directions of the cholesteric liquid crystals CL1 adjacent to each other along the first direction X differ from each other. In the plurality of cholesteric liquid crystals CL1 adjacent to each other along the first direction X, the alignment directions of liquid crystal molecules LM11 located in the same plane differ from each other.

The reflective surface 11R indicated by one-dot chain line in the figure corresponds to a surface in which the alignment directions of the liquid crystal molecules LM1 are uniform, or a surface (an equiphase surface) in which the spatial phase is uniform. The reflective surface 11R is inclined at an acute angle θ11 relative to the second main surface 1B, with the side close to the second side surface 1D located farther from transparent substrate 1 than the side close to the first side surface 1C.

With respect to one of the cholesteric liquid crystals CL2 surrounded by broken lines in the liquid crystal layer 12, the cholesteric liquid crystal CL2 consists of a plurality of liquid crystal molecules LM2 helically stacked along the third direction Z while twisting. FIG. 2 shows the liquid crystal molecules LM2 constituting the cholesteric liquid crystal CL2 in the liquid crystal layer 12 in the same simplified manner as the liquid crystal layer 11.

In the illustrated X-Z cross section, the alignment directions of the cholesteric liquid crystals CL2 adjacent to each other along the first direction X differ from each other. In the plurality of cholesteric liquid crystals CL2 adjacent to each other along the first direction X, the alignment directions of liquid crystal molecules LM21 located in the same plane differ from each other.

The reflective surface 12R indicated by one-dot chain line in the figure corresponds to a surface in which the alignment directions of the liquid crystal molecules LM2 are uniform, or a surface (an equiphase surface) in which the spatial phase is uniform. The reflective surface 12R is inclined at an acute angle θ12 relative to the second main surface 1B, with the side close to the second side surface 1D located farther from the transparent substrate 1 than the side close to the first side surface 1C. In one example, the reflective surface 12R is parallel to the reflective surface 11R, although they may be non-parallel to each other.

The liquid crystal layer 11 and the liquid crystal layer 12 are cured in a state where the alignment directions of the liquid crystal molecules are fixed. That is, unlike those of general liquid crystal elements, the alignment directions of the liquid crystal molecules are not controlled by an electric field.

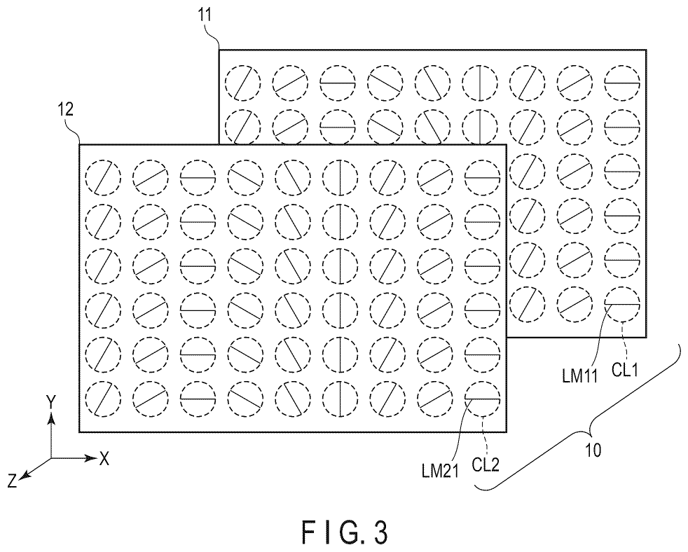

FIG. 3 is a plan view schematically showing the liquid crystal layer 11 and the liquid crystal layer 12 shown in FIG. 2.

FIG. 3 shows an example of the spatial phases of the cholesteric liquid crystals CL1 in the liquid crystal layer 11. Here, the spatial phases are shown as the alignment directions of the liquid crystal molecules LM11 contained in the cholesteric liquid crystals CL1 indicated by the dashed circle.

In the cholesteric liquid crystals CL1 arranged in the second direction Y, the alignment directions of the liquid crystal molecules LM11 are substantially equivalent to each other. That is, the spatial phases of the cholesteric liquid crystals CL1 are substantially equivalent to each other in the second direction Y.

In the cholesteric liquid crystals CL1 arranged along the first direction X, the alignment directions of the liquid crystal molecules LM11 differ from each other. That is, the spatial phases of the cholesteric liquid crystals CL1 differ along the first direction X.

In particular, regarding the cholesteric liquid crystals CL1 arranged in the first direction X, the alignment direction varies with each liquid crystal molecule LM11 by a certain degree. That is, the alignment direction linearly varies with the liquid crystal molecules LM11 arranged in the first direction X. Thus, the reflective surface 11R inclined relative to the X-Y plane or the second main surface 1B is formed as shown in FIG. 1 and FIG. 2. Here, the phrase “linearly vary” means that, for example, the amount of variation in the alignment directions of the liquid crystal molecules LM11 is shown by a linear function. Here, the alignment direction of each liquid crystal molecule LM11 corresponds to the long axis direction of the liquid crystal molecule LM11 in the X-Y plane.

FIG. 3 shows an example of the spatial phases of the cholesteric liquid crystals CL2 in the liquid crystal layer 12. Here, the spatial phases are shown as the alignment directions of the liquid crystal molecules LM21 contained in the cholesteric liquid crystals CL2 indicated by the dashed circle.

In the cholesteric liquid crystals CL2 arranged along the second direction Y, the alignment directions of the liquid crystal molecules LM21 are substantially equivalent to each other.

In the cholesteric liquid crystals CL2 arranged along the first direction X, the alignment directions of the liquid crystal molecules LM21 differ from each other. Thus, the spatial phase of the cholesteric liquid crystal CL2 differs along the first direction X and is substantially identical along the second direction Y.

In particular, regarding the cholesteric liquid crystals CL2 arranged in the first direction X, the alignment direction varies with each liquid crystal molecule LM21 by a certain degree. Thus, the reflective surface 12R inclined relative to the X-Y plane or the second main surface 1B is formed as shown in FIG. 1 and FIG. 2.

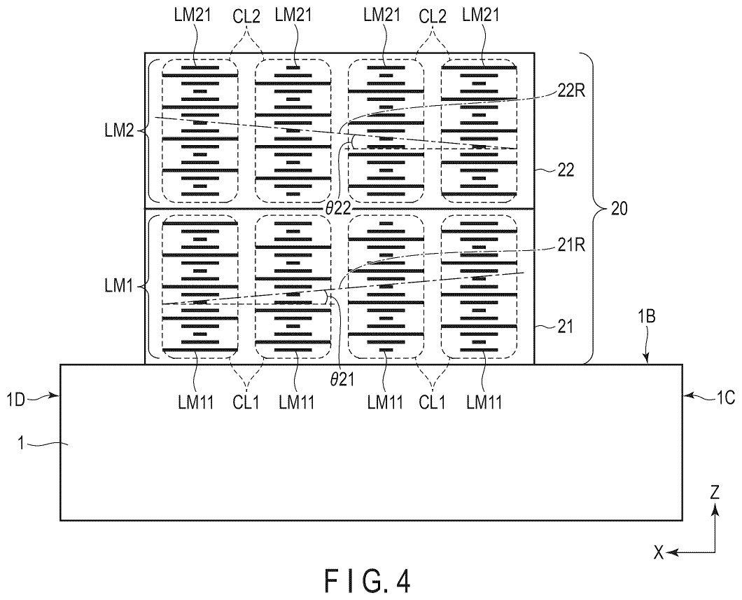

FIG. 4 is a cross-sectional view for describing an example of the cholesteric liquid crystal CL1 contained in the liquid crystal layer 21 and the cholesteric liquid crystal CL2 contained in the liquid crystal layer 22 shown in FIG. 1.

In the same manner as the liquid crystal layer 11, with respect to one of the cholesteric liquid crystals CL1 surrounded by broken lines in the liquid crystal layer 11, the cholesteric liquid crystal CL1 consists of the plurality of liquid crystal molecules LM1 helically stacked along the third direction Z while twisting.

In the illustrated X-Z cross section, the alignment directions of the cholesteric liquid crystals CL1 adjacent to each other along the first direction X differ from each other. In the plurality of cholesteric liquid crystals CL1 adjacent to each other along the first direction X, the alignment directions of the liquid crystal molecules LM11 located in the same plane differ from each other.

The reflective surface 21R indicated by one-dot chain line in the figure corresponds to a surface in which the alignment directions of the liquid crystal molecules LM1 are uniform, or a surface (an equiphase surface) in which the spatial phase is uniform. The reflective surface 21R is inclined at an acute angle θ21 relative to the second main surface 1B, with the side close to the second side surface 1C located farther from the transparent substrate 1 than the side close to the second side surface 1D.

In the same manner as the liquid crystal layer 12, with respect to one of the cholesteric liquid crystals CL2 surrounded by broken lines in the liquid crystal layer 12, the cholesteric liquid crystal CL2 consists of a plurality of liquid crystal molecules LM2 helically stacked along the third direction Z while twisting.

In the illustrated X-Z cross section, the alignment directions of the cholesteric liquid crystals CL2 adjacent to each other along the first direction X differ from each other. In the plurality of cholesteric liquid crystals CL2 adjacent to each other along the first direction X, the alignment directions of the liquid crystal molecules LM21 located in the same plane differ from each other.

The reflective surface 22R indicated by one-dot chain line in the figure corresponds to a surface in which the alignment directions of the liquid crystal molecules LM2 are uniform, or a surface (an equiphase surface) in which the spatial phase is uniform. The reflective surface 22R is inclined at an acute angle θ22 relative to the second main surface 1B, with the side close to the second side surface 1D located farther from the transparent substrate 1 than the side close to the first side surface 1C. That is, the reflective surface 22R is not parallel to the reflective surface 21R.

The liquid crystal layer 21 and the liquid crystal layer 22 are cured in a state where the alignment directions of the liquid crystal molecules are fixed. That is, unlike those of general liquid crystal elements, the alignment directions of the liquid crystal molecules are not controlled by an electric field.

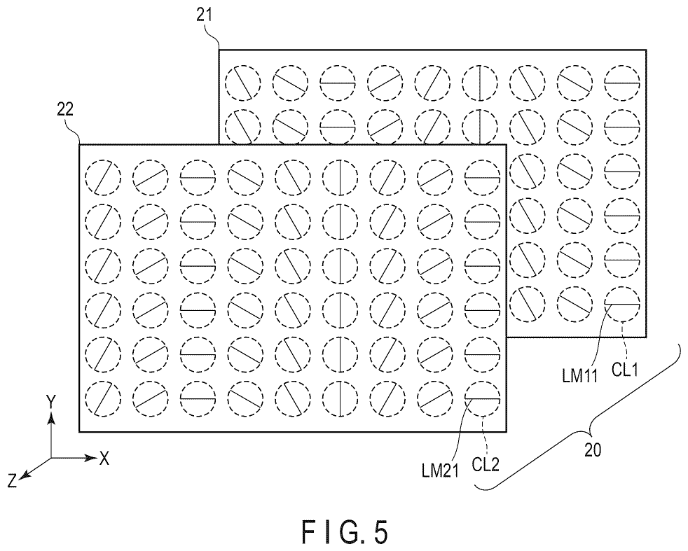

FIG. 5 is a plan view schematically illustrating the liquid crystal layer 21 and the liquid crystal layer 22 shown in FIG. 4.

FIG. 5 shows an example of the spatial phases of the cholesteric liquid crystals CL1 in the liquid crystal layer 21. Here, the spatial phases are shown as the alignment directions of the liquid crystal molecules LM11 contained in the cholesteric liquid crystals CL1 indicated by the dashed circle.

In the cholesteric liquid crystals CL1 arranged in the second direction Y, the alignment directions of the liquid crystal molecules LM11 are substantially equivalent to each other.

In the cholesteric liquid crystals CL1 arranged along the first direction X, the alignment directions of the liquid crystal molecules LM11 differ from each other. Thus, the spatial phase of the cholesteric liquid crystal CL1 differs along the first direction X and is substantially identical along the second direction Y.

In particular, regarding the cholesteric liquid crystals CL1 arranged in the first direction X, the alignment direction varies with each liquid crystal molecule LM11 by a certain degree. Thus, the reflective surface 21R inclined relative to the X-Y plane or the second main surface 1B is formed as shown in FIG. 1 and FIG. 4.

FIG. 5 shows an example of the spatial phases of the cholesteric liquid crystals CL2 in the liquid crystal layer 12. Here, the spatial phases are shown as the alignment directions of the liquid crystal molecules LM21 contained in the cholesteric liquid crystals CL2 indicated by the dashed circle.

In the cholesteric liquid crystals CL2 arranged along the second direction Y, the alignment directions of the liquid crystal molecules LM21 are substantially equivalent to each other.

In the cholesteric liquid crystals CL2 arranged along the first direction X, the alignment directions of the liquid crystal molecules LM21 differ from each other. Thus, the spatial phase of the cholesteric liquid crystal CL2 differs along the first direction X and is substantially identical along the second direction Y.

In particular, regarding the cholesteric liquid crystals CL2 arranged in the first direction X, the alignment direction varies with each liquid crystal molecule LM21 by a certain degree. Thus, the reflective surface 22R inclined relative to the X-Y plane or the second main surface 1B is formed as shown in FIG. 1 and FIG. 4.

Next, the following will describe the display module DM.

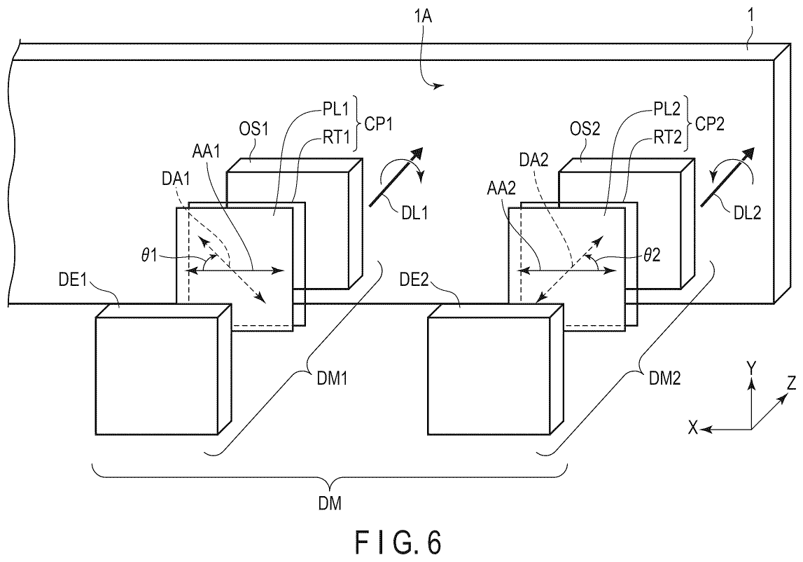

FIG. 6 is a perspective view for explaining the display module DM shown in FIG. 1.

The first display module DM1 includes a display element DE1, a circularly polarization element CP1, and an optical system OS1. The second display module DM2 includes a display element DE2, a circularly polarization element CP2, and an optical system OS2.

Each of the display elements DE1 and DE2 is configured to display images. Each of these display elements DE1 and DE2 may be, for example, a display element which comprises a self-luminous element such as an organic electroluminescent element or a light emitting diode, or may be a display element in which an optical switch and an illumination device are combined with each other such as a liquid crystal panel.

The circularly polarization element CP1 faces the display element DE1 in the third direction Z and is configured to generate circularly polarized light. The circularly polarization element CP1 comprises a polarizer PL1 and a retardation film RT1. The polarizer PL1 is located between the display element DE1 and the retardation film RT1 in the third direction Z. The retardation film RT1 is a λ/4 plate.

A retardation axis DA1 of the retardation film RT1 and an absorption axis AA1 of the polarizer PL1 intersect each other in the X-Y plane. The retardation axis DA1 intersects the absorption axis AA1 at the acute angle θ1 in a right-handed (clockwise) direction. For example, the angle θ1 is 45 degrees.

The optical system OS1 faces the circularly polarization element CP1 and is located between the transparent substrate 1 and the retardation film RT1 in the third direction Z. The optical system OS1 comprises at least one lens and is configured to generate collimated light.

Thus, light corresponding to an image displayed on the display element DE1 is converted into linearly polarized light by the polarizer PL1, converted into right-handed circularly polarized light by the retardation film RT1, and collimated by the optical system OS1. Then, this collimated light is emitted as the first display light DL1 of the first circularly polarized light from the first display module DM1.

The circularly polarization element CP2 faces the display element DE2 in the third direction Z and is configured to generate circularly polarized light. The circularly polarization element CP2 comprises a polarizer PL2 and a retardation film RT2. The polarizer PL2 is located between the display element DE2 and the retardation film RT2 in the third direction Z. The retardation film RT2 is a λ/4 plate.

A retardation axis DA2 of the retardation film RT2 and an absorption axis AA2 of the polarizer PL2 intersect each other in the X-Y plane. The retardation axis DA2 intersects the absorption axis AA2 at the acute angle θ2 in a left-handed (counter-clockwise) direction. For example, the angle θ2 is 45 degrees.

The optical system OS2 faces the circularly polarization element CP2 and is located between the transparent substrate 1 and the retardation film RT2 in the third direction Z. The optical system OS2 comprises at least one lens and is configured to generate collimated light.

Thus, light corresponding to an image displayed on the display element DE2 is converted into linearly polarized light by the polarizer PL2, converted into left-handed circularly polarized light by the retardation film RT2, and collimated by the optical system OS2. Then, this collimated light is emitted as the second display light DL2 of the second circularly polarized light from the second display module DM2.

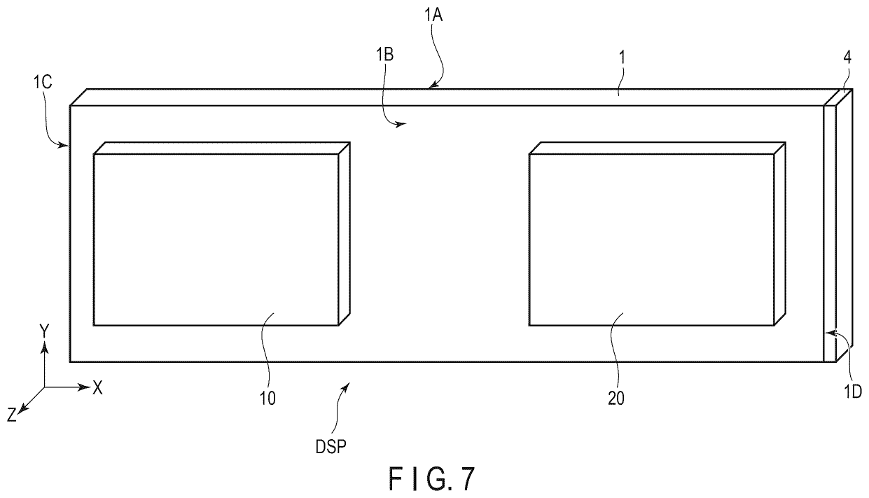

FIG. 7 is a perspective view of the display device DSP. FIG. 7 omits the illustration of the display module DM located on the side facing the first main surface 1A of the transparent substrate 1.

In the transparent substrate 1, each of the first main surface 1A and the second main surface 1B is formed in a rectangular shape having a pair of long sides extending in the first direction X and a pair of short sides extending in the second direction Y.

The first optical element 10 and the second optical element 20 provided on the second main surface 1B are arranged at an interval in the first direction X. The first optical element 10 is located on the side close to the first side surface 1C in the second main surface 1B. The second optical element 20 is located on the side close to the second side surface 1D in the second main surface 1B.

The following will describe some usage examples of the display device DSP.

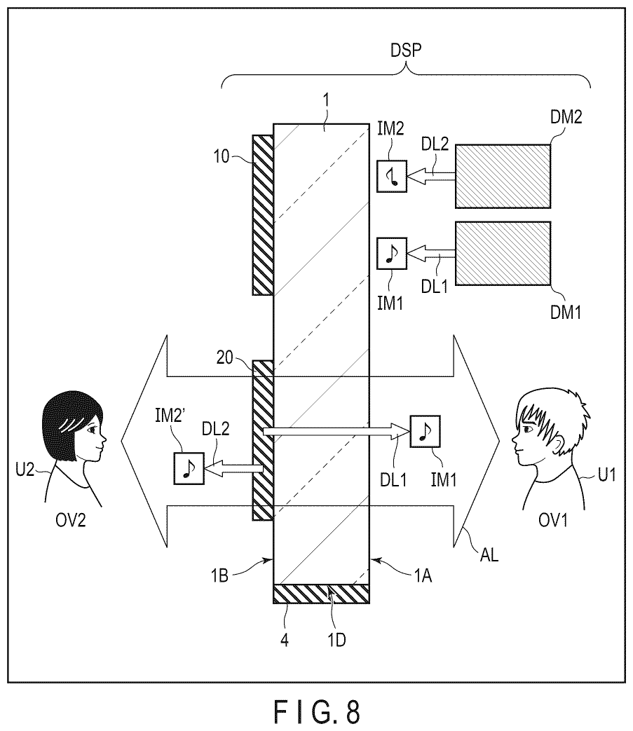

FIG. 8 is a view for describing a usage of the display device DSP.

The first display module DM1 emits the first display light DL1 corresponding to a first image IM1. The second display module DM2 emits the second display light DL2 corresponding to a second image IM2. The second image IM2 corresponds to an image obtained by horizontally inverting the first image IM1.

As described above, each of the first display light DL1 and the second display light DL2 is reflected by the first optical element 10 and then propagates inside the transparent substrate 1 and is reflected by the second optical element 20. At this time, the user U1 at the first observation position OV1 can observe the first image IM1 corresponding to the first display light DL1. Further, the user U2 at the second observation position OV2 can observe a second image IM2′ corresponding to the second display light DL2. The second image IM2′ corresponds to an image obtained by horizontally inverting the second image IM2. That is, the second image IM2′ is identical to the first image IM1.

Thus, the users U1 and U2 facing each other across the display device DSP can observe the same image. Even when the first image IM1 and the second image IM2′ include characters, the characters do not appear inverted. Thus, image visibility can be improved.

Further, the users U1 and U2 can observe an external light AL through a display device DSP. Thus, the user U1 can observe the user U2 behind the display device DSP while observing the first image IM1. Similarly, the user U2 can observe the user U1 behind the display device DSP while observing the second image IM2′.

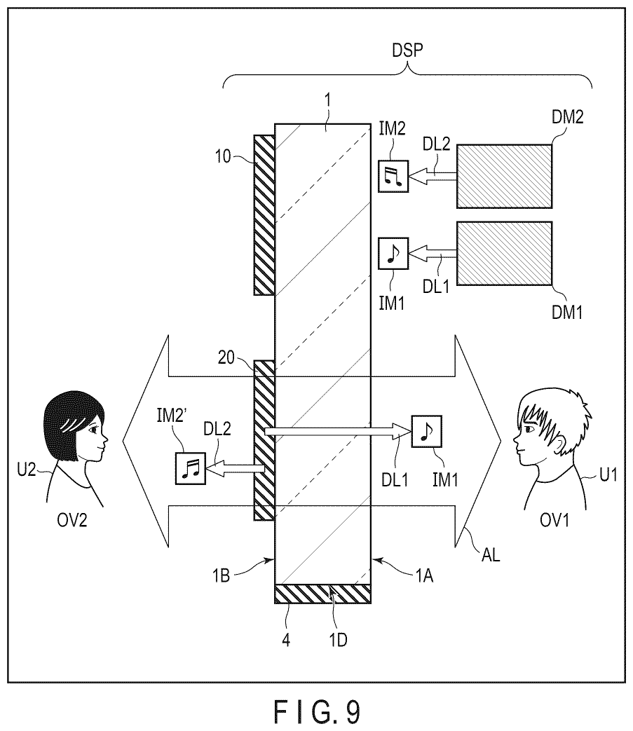

FIG. 9 is a view for describing another usage of the display device DSP.

The first display module DM1 emits the first display light DL1 corresponding to the first image IM1. The second display module DM2 emits the second display light DL2 corresponding to the second image IM2. The second image IM2 differs from the first image IM1. Further, the second image IM2 corresponds to an image obtained by horizontally inverting an originally intended image to be displayed.

As described above, each of the first display light DL1 and the second display light DL2 is reflected by the first optical element 10 and then propagates inside the transparent substrate 1 and is reflected by the second optical element 20. At this time, the user U1 at the first observation position OV1 can observe the first image IM1 corresponding to the first display light DL1. Further, the user U2 at the second observation position OV2 can observe a second image IM2′ corresponding to the second display light DL2. The second image IM2′ corresponds to an image obtained by horizontally inverting the second image IM2.

Thus, the users U1 and U2 facing each other across the display device DSP can observe mutually different images. Even when the first image IM1 and the second image IM2′ include characters, the characters do not appear inverted. Thus, image visibility can be improved.

Further, the users U1 and U2 can observe the external light AL through a display device DSP. Thus, the user U1 can observe the user U2 behind the display device DSP while observing the first image IM1. Similarly, the user U2 can observe the user U1 behind the display device DSP while observing the second image IM2′.

In this configuration example, the liquid crystal layer 11 corresponds to the first liquid crystal layer of the first optical element 10. The liquid crystal layer 12 corresponds to the second liquid crystal layer of the first optical element 10. The liquid crystal layer 21 corresponds to the first liquid crystal layer of the second optical element 20. The liquid crystal layer 22 corresponds to the second liquid crystal layer of the second optical element 20. Furthermore, the cholesteric liquid crystal CL1 corresponds to the first cholesteric liquid crystal. The cholesteric liquid crystal CL2 corresponds to the second cholesteric liquid crystal. The helical pitch P1 and the helical pitch P2 correspond to the first helical pitch. The reflective surface 11R corresponds to the first reflective surface of the first optical element 10. The reflective surface 12R corresponds to the second reflective surface of the first optical element 10. The reflective surface 21R corresponds to the first reflective surface of the second optical element 20. The reflective surface 22R corresponds to the second reflective surface of the second optical element 20.

Here, the following will briefly describe an example of a manufacturing method for the liquid crystal layer applied to each of the first optical element 10 and the second optical element 20.

First, an alignment film is formed on a separate support substrate different from the transparent substrate 1. The alignment film has an alignment axis of a prescribed alignment pattern. For example, this prescribed alignment pattern is formed by applying an interference exposure method using right-handed circularly polarized light and left-handed circularly polarized light. Then, a solution containing a polymerizable liquid crystal material and a polymerization initiator are applied onto the alignment film. The solvent of the coated solution is removed by vacuum drying. Then, the polymerizable liquid crystal material is heated to a temperature not exceeding the NI point (nematic-isotropic transition temperature) and subsequently cooled. In this process, the liquid crystal molecules contained in the polymerizable liquid crystal materials are arranged in a helical shape by an alignment restriction force of the alignment film. Then, the polymerizable liquid crystal material and polymerization initiator are irradiated with ultraviolet light. Thus, the liquid crystal molecules are cured into a polymeric liquid crystal materials while exhibiting a cholesteric liquid crystal phase. Thus, the liquid crystal layer is formed. The liquid crystal layer formed in this manner is stripped from the alignment film and then is transferred onto the transparent substrate 1 or other liquid crystal layers.

Next, the following will describe several other configurations. The same constituent elements as in the above configuration example are denoted by the same reference numerals and their overlapping explanations are omitted in some cases.

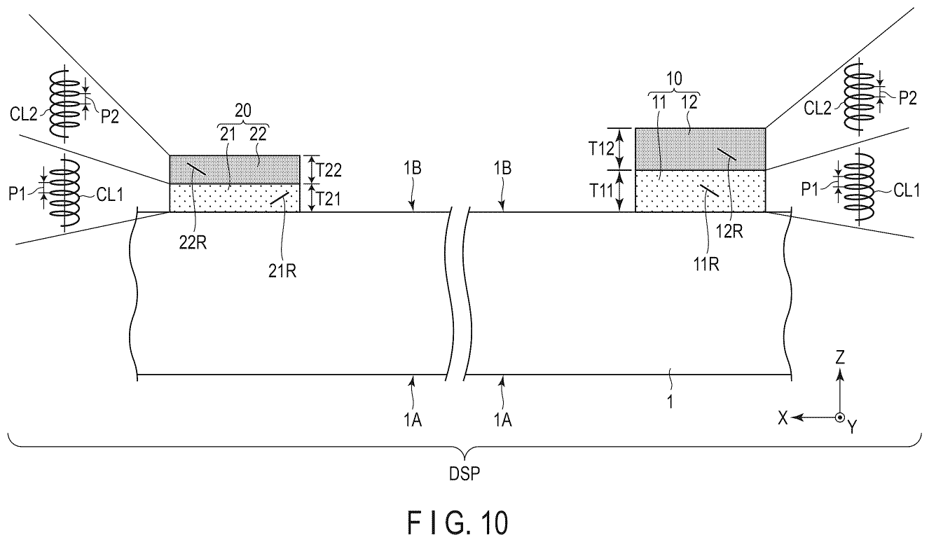

FIG. 10 is a view showing another configuration example of the display device DSP. FIG. 10, omits the illustrations of the display modules and shows the first optical element 10 and the second optical element 20 in an enlarged manner.

In the third direction Z, the liquid crystal layer 11 has a thickness T11, and the liquid crystal layer 12 has a thickness T12. For example, the diffraction efficiency is defined as the ratio of the intensity of the reflected light (the first diffraction light) in the liquid crystal layer to the intensity of the incident light. In this case, each of the thickness T11 and the thickness T12 is preferably several times to about ten times the helical pitch in order to improve the diffraction efficiency in the liquid crystal layer 11 and the liquid crystal layer 12. In one example, the thickness T11 and the thickness T12 are equivalent to each other and are approximately 3 μm. Furthermore, the diffraction efficiency of the liquid crystal layer 12 is equivalent to that of the liquid crystal layer 11. Thus, light utilization efficiency can be improved in the first optical element 10 including the liquid crystal layer 11 and the liquid crystal layer 12.

In the third direction Z, the liquid crystal layer 21 has a thickness T21, and the liquid crystal layer 22 has a thickness T22. The liquid crystal layer 21 is thinner than the liquid crystal layer 11. That is, the thickness T21 is smaller than the thickness T11 (T21<T11). The liquid crystal layer 22 is thinner than the liquid crystal layer 12. That is, the thickness T22 is smaller than the thickness T12 (T22<T12). In one example, the thicknesses T21 and T22 are approximately 1 μm to 2 μm.

Thus, the diffraction efficiency of the liquid crystal layer 21 is smaller than that of the liquid crystal layer 11. Further, the diffraction efficiency of the liquid crystal layer 22 is smaller than that of the liquid crystal layer 12. Light utilization efficiency can be improved in the second optical element 20 including the liquid crystal layer 21 and the liquid crystal layer 22. That is, in the usage examples shown in FIG. 8 and FIG. 9, visibility of the background of the display device DSP (e.g., the user U2 at the second observation position OV2) improves for the user U1. Similarly, visibility of the background of the display device DSP (e.g., the user U1 at the first observation position OV1) improves for the user U2.

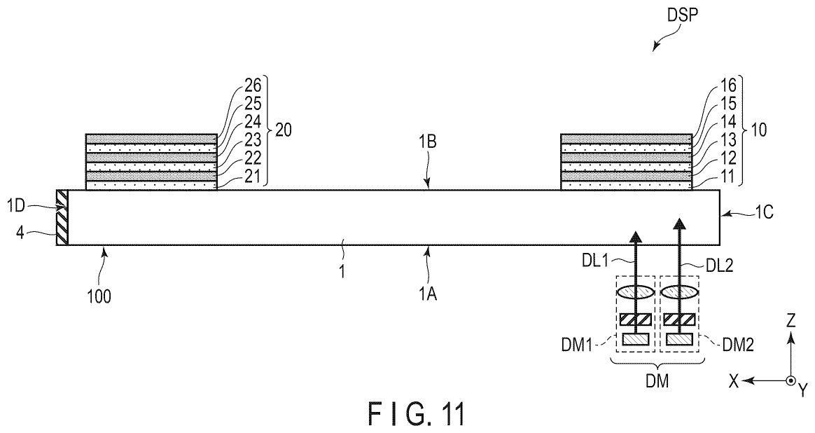

FIG. 11 is a view showing another configuration example of the display device DSP.

The configuration example shown in FIG. 11 differs from the configuration example shown in FIG. 1 in that the display device DSP is configured to enable multicolor display.

In addition to the liquid crystal layer 11 and the liquid crystal layer 12, the first optical element 10 comprises a liquid crystal layer 13, a liquid crystal layer 14, a liquid crystal layer 15, and a liquid crystal layer 16. In the illustrated example, the liquid crystal layer 11, the liquid crystal layer 12, the liquid crystal layer 13, the liquid crystal layer 14, the liquid crystal layer 15, and the liquid crystal layer 16 are stacked in this order along the third direction Z.

In addition to the liquid crystal layer 21 and the liquid crystal layer 22, the second optical element 20 comprises a liquid crystal layer 23, a liquid crystal layer 24, a liquid crystal layer 25, and a liquid crystal layer 26. In the illustrated example, the liquid crystal layer 21, the liquid crystal layer 22, the liquid crystal layer 23, the liquid crystal layer 24, the liquid crystal layer 25, and the liquid crystal layer 26 are stacked in this order along the third direction Z.

The stacking order of the plurality of liquid crystal layers in the first optical element 10 and the second optical element 20 is not limited to the illustrated example.

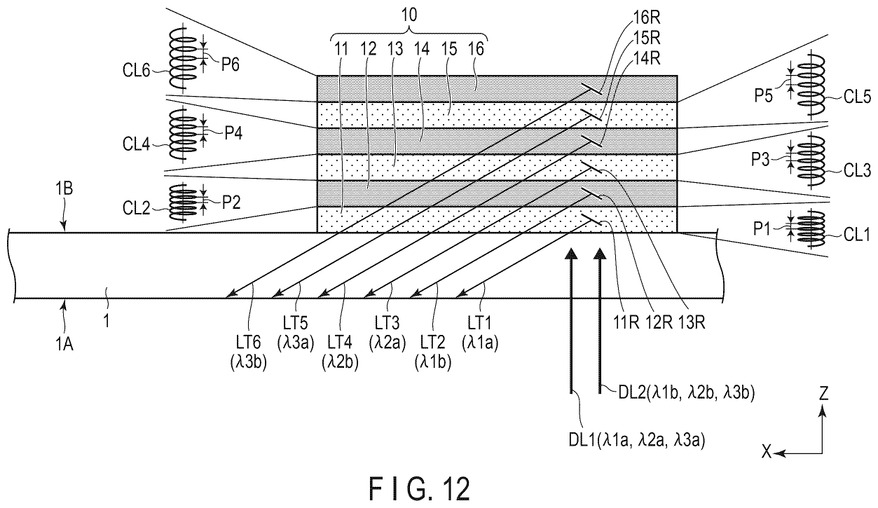

FIG. 12 is a view for describing the first optical element 10 of the display device DSP shown in FIG. 11.

As shown enlarged and schematically, the liquid crystal layer 11, the liquid crystal layer 12, the liquid crystal layer 13, the liquid crystal layer 14, the liquid crystal layer 15, and the liquid crystal layer 16 contain the cholesteric liquid crystal CL1, the cholesteric liquid crystal CL2, the cholesteric liquid crystal CL3, the cholesteric liquid crystal CL4, the cholesteric liquid crystal CL5, and the cholesteric liquid crystal CL6, respectively.

The cholesteric liquid crystal CL1 has the helical pitch P1 in the third direction Z. The liquid crystal layer 11 has the reflective surface 11R.

The cholesteric liquid crystal CL2 is twisted in the opposite direction to the cholesteric liquid crystal CL1 and has the helical pitch P2 along the third direction Z. The helical pitch P2 is equivalent to the helical pitch P1. The liquid crystal layer 12 has the reflective surface 12R.

The cholesteric liquid crystal CL3 has a helical pitch P3 along the third direction Z. The helical pitch P3 differs from the helical pitch P1. The liquid crystal layer 13 has a reflective surface 13R.

The cholesteric liquid crystal CL4 is twisted in the opposite direction to the cholesteric liquid crystal CL3 and has a helical pitch P4 along the third direction Z. The helical pitch P4 is equivalent to the helical pitch P3. The liquid crystal layer 14 has a reflective surface 14R.

The cholesteric liquid crystal CL5 has a helical pitch P5 along the third direction Z. The helical pitch P5 differs from both of the helical pitch P1 and the helical pitch P3. The liquid crystal layer 15 has a reflective surface 15R.

The cholesteric liquid crystal CL6 is twisted in the opposite direction to the cholesteric liquid crystal CL5 and has a helical pitch P6 along the third direction Z. The helical pitch P6 is equivalent to the helical pitch P5. The liquid crystal layer 16 has a reflective surface 16R.

The cholesteric liquid crystal CL1, the cholesteric liquid crystal CL3, and the cholesteric liquid crystal CL5 are twisted in the same direction. The cholesteric liquid crystal CL2, the cholesteric liquid crystal CL4, and the cholesteric liquid crystal CL6 are twisted in the same direction.

The helical pitch P1, the helical pitch P3, and the helical pitch P5 differ from each other. In the illustrated example, the helical pitch P3 is larger than the helical pitch P1, and the helical pitch P5 is larger than the helical pitch P3 (P1<P3<P5).

The helical pitch P2, the helical pitch P4, and the helical pitch P6 differ from each other. In the illustrated example, the helical pitch P4 is larger than the helical pitch P2, and the helical pitch P6 is larger than the helical pitch P4 (P2<P4<P6).

The following explanation assumes that the first display light DL1 includes a right-handed circularly polarized light λ1a in the first wavelength λ1, a right-handed circularly polarized light λ2a in the second wavelength λ2, and a right-handed circularly polarized light λ3a in the third wavelength λ3, and that the second display light DL2 includes a left-handed circularly polarized light λ1b in the first wavelength λ1, a left-handed circularly polarized light λ2b in the second wavelength λ2, and a left-handed circularly polarized light λ3b in the third wavelength λ3. The second wavelength range λ2 is in a longer wavelength than the first wavelength range λ1, and the third wavelength range λ3 is in a longer wavelength range than the second wavelength range λ2.

The reflective surfaces 11R and 12R are configured to reflect light in the first wavelength range λ1 as the selective reflection range. The light LT1 reflected by the reflective surface 11R is the right-handed circularly polarized light λ1a in the first wavelength range λ1. Further, the light LT2 reflected by the reflective surface 12R is the left-handed circularly polarized light λ1b in the first wavelength range λ1.

The reflective surfaces 13R and 14R are configured to reflect light in the second wavelength range λ2 as the selective reflection range. A light LT3 reflected by the reflective surface 13R is the right-handed circularly polarized light λ2a in the second wavelength range λ2. Further, a light LT4 reflected by the reflective surface 14R is the left-handed circularly polarized light λ2b in the second wavelength range λ2.

The reflective surfaces 15R and 16R are configured to reflect light in the third wavelength range λ3 as the selective reflection range. A light LT5 reflected by the reflective surface 15R is the right-handed circularly polarized light λ3a in the third wavelength range λ3. Further, a light LT6 reflected by the reflective surface 16R is the left-handed circularly polarized light λ3b in the third wavelength range λ3.

The liquid crystal layer 11, the liquid crystal layer 13, and the liquid crystal layer 15 are configured to reflect the first display light DL1 toward the second optical element 20. Each of the light LT1, the light LT3, and the light LT5 propagates along the first direction X while undergoing total reflection at the first main surface 1A and the second main surface 1B of the transparent substrate 1.

The liquid crystal layer 12, the liquid crystal layer 14, and the liquid crystal layer 16 are configured to reflect the second display light DL2 toward the second optical element 20. Each of the light LT2, the light LT4, and the light LT6 propagates along the first direction X while undergoing total reflection at the first main surface 1A and the second main surface 1B of the transparent substrate 1.

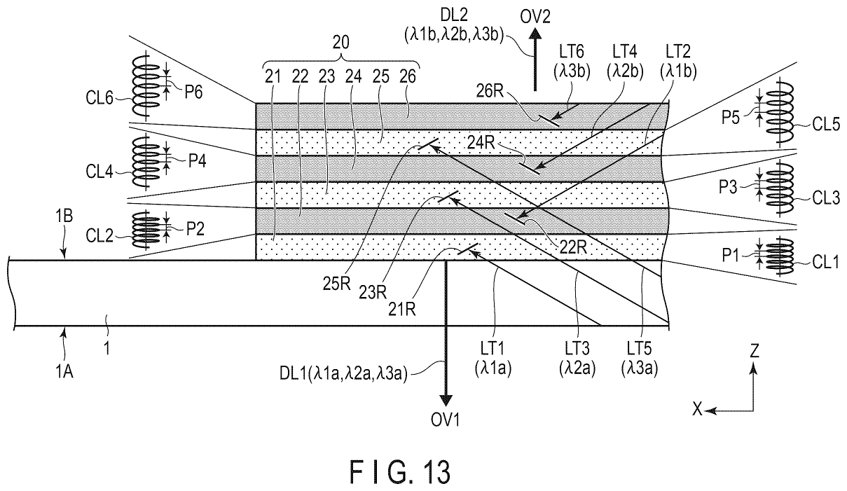

FIG. 13 is a view for describing the second optical element 20 of the display device DSP shown in FIG. 11.

As shown enlarged and schematically, the liquid crystal layer 21, the liquid crystal layer 22, the liquid crystal layer 23, the liquid crystal layer 24, the liquid crystal layer 25, and the liquid crystal layer 26 contain the cholesteric liquid crystal CL1, the cholesteric liquid crystal CL2, the cholesteric liquid crystal CL3, the cholesteric liquid crystal CL4, the cholesteric liquid crystal CL5, and the cholesteric liquid crystal CL6, respectively.

That is, the liquid crystal layer 21 has the same configuration as the liquid crystal layer 11, the liquid crystal layer 22 has the same configuration as the liquid crystal layer 12, the liquid crystal layer 23 has the same configuration as the liquid crystal layer 13, the liquid crystal layer 24 has the same configuration as the liquid crystal layer 14, the liquid crystal layer 25 has the same configuration as the liquid crystal layer 15, and the liquid crystal layer 26 has the same configuration as the liquid crystal layer 16. However, inclinations of the reflective surfaces 21R, 23R, and 25R differ from those of the respective reflective surfaces 11R, 13R, and 15R.

The liquid crystal layer 21 has the reflective surface 21R reflecting the light LT1 reflected by the liquid crystal layer 11. The light LT1 reflected by the reflective surface 21R is the right-handed circularly polarized light λ1a in the first wavelength range λ1. The liquid crystal layer 21 is configured to reflect the light LT1 along the normal to the transparent substrate 1.

The liquid crystal layer 23 has the reflective surface 23R reflecting the light LT3 reflected by the liquid crystal layer 13. The light LT3 reflected by the reflective surface 23R is the right-handed circularly polarized light λ2a in the second wavelength range λ2. The liquid crystal layer 23 is configured to reflect the light LT3 along the normal to the transparent substrate 1.

The liquid crystal layer 25 has the reflective surface 25R reflecting the light LT5 reflected by the liquid crystal layer 15. The light LT5 reflected by the reflective surface 25R is the right-handed circularly polarized light λ3a in the third wavelength range λ3. The liquid crystal layer 25 is configured to reflect the light LT5 along the normal to the transparent substrate 1.

The light LT1 (the circularly polarized light λ1a), the light LT3 (the circularly polarized light λ2a), and the light LT5 (the circularly polarized light λ3a), which constitute the first display light DL1, are reflected toward the first observation position OV1.

The liquid crystal layer 22 has the reflective surface 22R reflecting the light LT2 reflected by the liquid crystal layer 12. Further, the light LT2 reflected by the reflective surface 22R is the left-handed circularly polarized light λ1b in the first wavelength range λ1. The liquid crystal layer 22 is configured to reflect the light LT2 along the normal to the transparent substrate 1.

The liquid crystal layer 24 has a reflective surface 24R reflecting the light LT4 reflected by the liquid crystal layer 14. Further, the light LT4 reflected by the reflective surface 24R is the left-handed circularly polarized light λ2b in the second wavelength range λ2. The liquid crystal layer 24 is configured to reflect the light LT4 along the normal to the transparent substrate 1.

The liquid crystal layer 26 has a reflective surface 26R reflecting the light LT6 reflected by the liquid crystal layer 16. Further, the light LT6 reflected by the reflective surface 26R is the left-handed circularly polarized light λ3b in the third wavelength range λ3. The liquid crystal layer 26 is configured to reflect the light LT6 along the normal to the transparent substrate 1.

The light LT2 (the circularly polarized light λ1b), the light LT4 (the circularly polarized light λ2b), and the light LT6 (the circularly polarized light λ3b), which constitute the second display light DL2, are reflected toward the second observation position OV2.

Thus, the display device DSP enables observation of the multicolor first image constituted by the first display light DL1 at the first observation position OV1 and observation of the multicolor second image constituted by the second display light DL2 at the second observation position OV2.

As explained with reference to FIG. 8 and FIG. 9, the first image is displayed on the first display module DM1 and the second image (inverted) is displayed on the second display module DM2. Thus, visibility of the multicolor first and second images can be improved.

In this manner, in the configuration example of the display device DSP capable of multicolor display, the liquid crystal layer 11 corresponds to the first liquid crystal layer of the first optical element 10. The liquid crystal layer 12 corresponds to the second liquid crystal layer of the first optical element 10. The liquid crystal layer 13 corresponds to the third liquid crystal layer of the first optical element 10. The liquid crystal layer 14 corresponds to the fourth liquid crystal layer of the first optical element 10. The liquid crystal layer 15 corresponds to the fifth liquid crystal layer of the first optical element 10. The liquid crystal layer 16 corresponds to the sixth liquid crystal layer of the first optical element 10.

The liquid crystal layer 21 corresponds to the first liquid crystal layer of the second optical element 20. The liquid crystal layer 22 corresponds to the second liquid crystal layer of the second optical element 20. The liquid crystal layer 23 corresponds to the third liquid crystal layer of the second optical element 20. The liquid crystal layer 24 corresponds to the fourth liquid crystal layer of the second optical element 20. The liquid crystal layer 25 corresponds to the fifth liquid crystal layer of the second optical element 20. The liquid crystal layer 26 corresponds to the sixth liquid crystal layer of the second optical element 20.

The cholesteric liquid crystal CL1 corresponds to the first cholesteric liquid crystal. The cholesteric liquid crystal CL2 corresponds to the second cholesteric liquid crystal. The cholesteric liquid crystal CL3 corresponds to the third cholesteric liquid crystal. The cholesteric liquid crystal CL4 corresponds to the fourth cholesteric liquid crystal. The cholesteric liquid crystal CL5 corresponds to the fifth cholesteric liquid crystal. The cholesteric liquid crystal CL6 corresponds to the sixth cholesteric liquid crystal. The helical pitch P1 and the helical pitch P2 correspond to the first helical pitch. The helical pitch P3 and the helical pitch P4 correspond to the second helical pitch. The helical pitch P5 and the helical pitch P6 correspond to the third helical pitch.

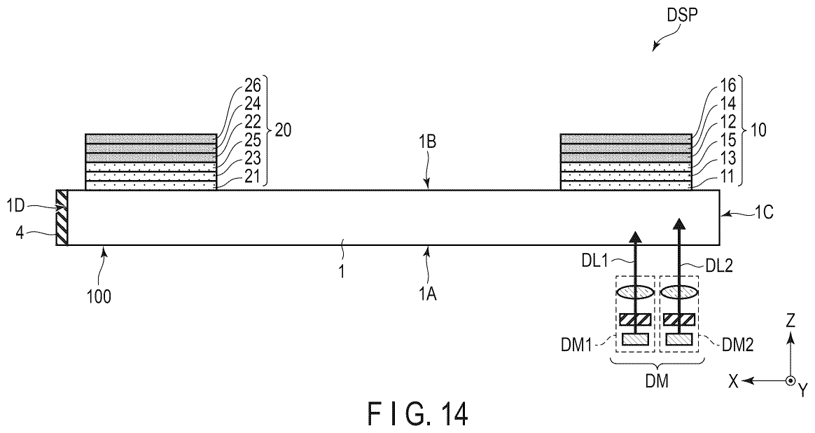

FIG. 14 is a view showing another configuration example of the display device DSP.

The configuration example shown in FIG. 14 differs from the configuration example shown in FIG. 11 in the stacking order of the liquid crystal layers included in the first optical element 10 and the second optical element 20.

In the first optical element 10, the liquid crystal layer 11, the liquid crystal layer 13, the liquid crystal layer 15, the liquid crystal layer 12, the liquid crystal layer 14, and the liquid crystal layer 16 are stacked in this order along third direction Z.

In the second optical element 20, the liquid crystal layer 21, the liquid crystal layer 23, the liquid crystal layer 25, the liquid crystal layer 22, the liquid crystal layer 24, and the liquid crystal layer 26 are stacked in this order along third direction Z.

This configuration example achieves the same effects as those achieved by the configuration example shown in FIG. 11.

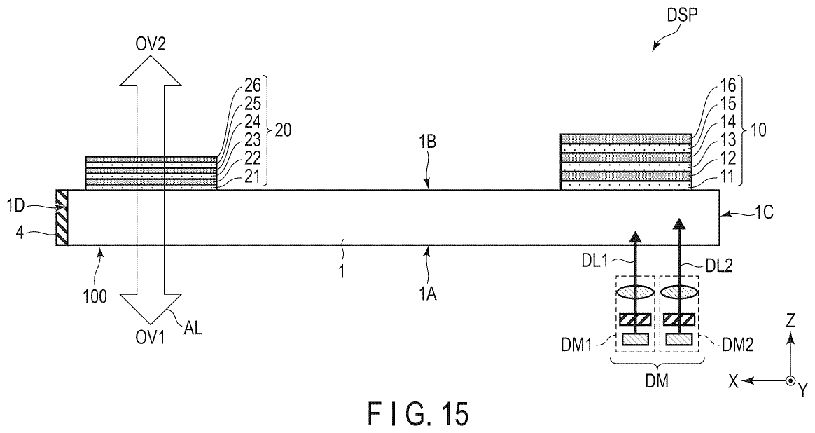

FIG. 15 is a view showing another configuration example of the display device DSP.

The configuration example shown in FIG. 15 differs from the configuration example shown in FIG. 11 in that the second optical element 20 is thinner than the first optical element 10.

The liquid crystal layer 21 is thinner than liquid crystal layer 11. The liquid crystal layer 22 is thinner than liquid crystal layer 12. The liquid crystal layer 23 is thinner than liquid crystal layer 13. The liquid crystal layer 24 is thinner than liquid crystal layer 14. The liquid crystal layer 25 is thinner than liquid crystal layer 15. The liquid crystal layer 26 is thinner than liquid crystal layer 16.

This configuration example achieves the same effects as those achieved by the configuration example shown in FIG. 11. Further, in the first optical element 10, a high diffraction efficiency is achieved and light-use efficiency is improved. Further, in the second optical element 20, transmittance is improved, and thus, visibility of the external light AL through display device DSP can be improved at both the first observation position OV1 and the second observation position OV2.

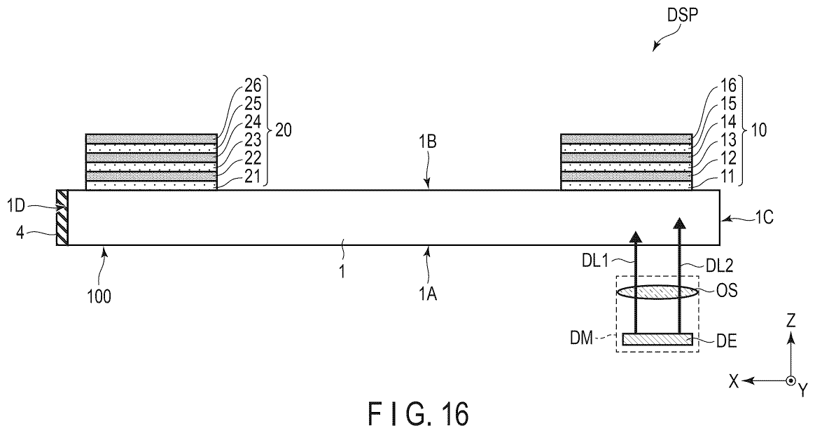

FIG. 16 is a view showing another configuration example of the display device DSP.

The configuration example shown in FIG. 16 differs from the configuration example shown in FIG. 11 in that the display module DM is a single display module configured to emit both of the first display light DL1 and the second display light DL2.

The display module DM comprises the display element DE and an optical system OS. The optical system OS is located between the display element DE and the transparent substrate 1 in the third direction Z.

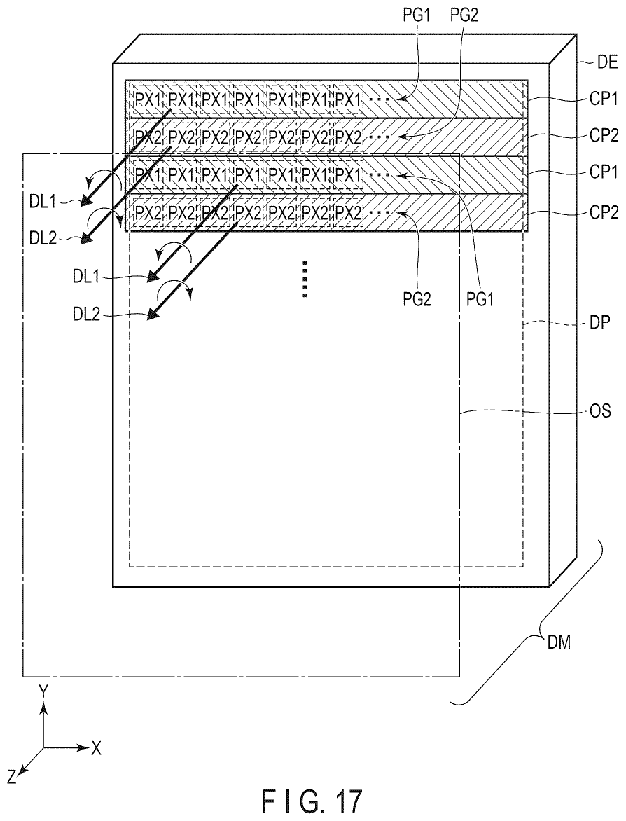

FIG. 17 is a view for explaining the display module DM shown in FIG. 16.

The display element DE is configured to display images. This display element DE may be, for example, a display element which comprises a self-luminous element such as an organic electroluminescent element or a light emitting diode, or may be a display element in which an optical switch and an illumination device are combined with each other such as a liquid crystal panel.

The display element DE comprises a first pixel group PG1 and a second pixel group PG2 in a display portion DP displaying images. In the illustrated example, the first pixel group PG1 includes a plurality of pixels PX1 arranged in the first direction X. Further, the second pixel group PG2 includes a plurality of pixels PX2 arranged in the first direction X. The first pixel group PG1 and the second pixel group PG2 are alternately arranged in the second direction Y.

The circularly polarization element CP1 (the first circularly polarization element) overlaps the first pixel group PG1 in third direction Z and is configured to generate the first display light DL1 as circularly polarized light. Though detailed explanations are omitted here, the circularly polarization element CP1 comprises the polarizer PL1 and the retardation film RT1 in the same manner as the circularly polarization element CP1 shown in FIG. 6.

The circularly polarization element CP2 (the second circularly polarization element) overlaps the second pixel group PG2 in third direction Z and is configured to generate the second display light DL2 as circularly polarized light. Though detailed explanations are omitted here, the circularly polarization element CP2 comprises the polarizer PL2 and the retardation film RT2 in the same manner as the circularly polarization element CP2 shown in FIG. 6.

The optical system OS indicated by a one-dot chain line faces the circularly polarization elements CP1 and CP2 in the third direction Z. The optical system OS comprises at least one lens and is configured to generate collimated light.

Accordingly, light corresponding to an image displayed in the first pixel group PG1 of the display element DE is converted into circularly polarized light by the circularly polarization element CP1, collimated by the optical system OS, and emitted from the display module DM as the first display light DL1, which is the first circularly polarized light.

Further, light corresponding to an image displayed in the second pixel group PG2 of the display element DE is converted into circularly polarized light by the circularly polarization element CP2, collimated by the optical system OS, and emitted from the display module DM as the second display light DL2, which is the second circularly polarized light.

The configuration examples shown in FIG. 16 and FIG. 17 achieve the same effects as those achieved by the configuration example shown in FIG. 11. Further, the display module DM can be downsized.

The single display module DM capable of emitting the first display light DL1 and the second display light DL2 is applicable to all of the configuration examples disclosed in the present specification.

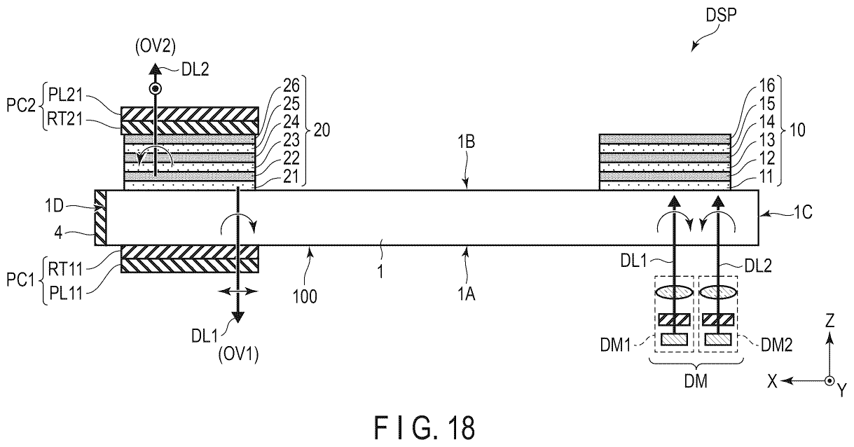

FIG. 18 is a view showing another configuration example of the display device DSP.

The configuration example shown in FIG. 18 differs from the configuration example shown in FIG. 11 in further comprising a first polarization-control element PC1 and a second polarization-control element PC2.

The first polarization-control element PC1 is provided on the first main surface 1A and faces the second optical element 20 across the transparent substrate 1 in the third direction Z. The first polarization-control element PC1 includes a polarizer PL11 and a retardation film RT11, which is a quarter wavelength plate (λ/4 plate). The retardation film RT11 is located between the polarizer PL11 and the transparent substrate 1 in the third direction Z.

The first polarization-control element PC1 transmits the first display light DL1, which is the first circularly polarized light, and absorbs the second display light DL2, which is the second circularly polarized light rotated in the opposite direction of the first display light DL1.

The second polarization-control element PC2 overlaps the second optical element 20 along the third direction Z. The second polarization-control element PC2 includes a polarizer PL21 and a retardation film RT21, which is a quarter wavelength plate (λ/4 plate). The retardation film RT21 is located between the polarizer PL21 and the second optical element 20 in the third direction Z.

The second polarization-control element PC2 transmits the second display light DL2, which is the second circularly polarized light, and absorbs the first display light DL1, which is the first circularly polarized light rotated in the opposite direction of the second display light DL2.

In the illustrated example, the first display light DL1 emitted from the first display module DM1 is right-handed circular polarization and, after being reflected by the first optical element 10 and propagating inside the transparent substrate 1, is reflected by the second optical element 20. The first display light DL1 reflected by the second optical element 20 is right-handed circularly polarized light and is converted into linear polarization in the first polarization-control element PC1 and is emitted toward the first observation position OV1.

The second display light DL2 emitted from the second display module DM2 is left-handed circular polarization and, after being reflected by the first optical element 10 and propagating inside the transparent substrate 1, is reflected by the second optical element 20. The second display light DL2 reflected by the second optical element 20 is left-handed circularly polarized light and is converted into linear polarization in the second polarization-control element PC2 and is emitted toward the second observation position OV2.

When the second display light DL2 propagating inside the transparent substrate 1 is undesirably emitted toward the first observation position OV1 due to unintended reflection, the second display light DL2, which is left-handed circularly polarized light, is absorbed by the first polarization-control element PC1. More specifically, the left-handed circularly polarized light emitted from the transparent substrate 1 is converted into linearly polarized light parallel to the absorption axis of the polarizer PL11 in the retardation film RT11.

Thus, at the first observation position OV1, the second display light DL2 does not mix with the first display light DL1. Thus, an image corresponding to the first display light DL1 can be observed with high clarity at the first observation position OV1.

When the first display light DL1 propagating inside the transparent substrate 1 is emitted from the second optical element 20 toward the second observation position OV2 due to unintended reflection, the first display light DL1, which is right-handed circularly polarized light, is absorbed by the second polarization-control element PC2. More specifically, the right-handed circularly polarized light emitted from the second optical element 20 is converted into linearly polarized light parallel to the absorption axis of the polarizer PL21 in the retardation film RT21.

Thus, at the second observation position OV2, the second display light DL2 does not mix with the first display light DL1. Thus, an image corresponding to the second display light DL2 can be observed with high clarity at the second observation position OV2.

The polarizers PL11 and PL21 may be film-type polarizers or liquid crystal cells including guest-host liquid crystal. The liquid crystal cell comprises a liquid crystal layer including guest-host liquid crystal between a pair of alignment films processed in an anti-parallel direction.

The first polarization-control element PC1 and the second polarization-control element PC2 are applicable to all of the configuration examples disclosed in the present specification.

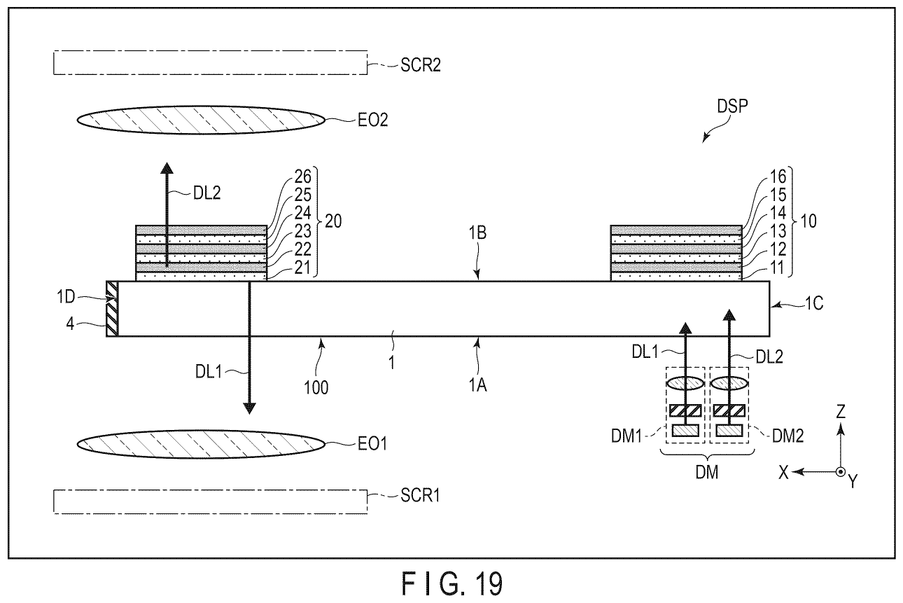

FIG. 19 is a view showing another configuration example of the display device DSP.

The configuration example shown in FIG. 19 differs from the configuration example shown in FIG. 11 in further comprising a first enlargement optical system EO1 and a second enlargement optical system EO2.

The first enlargement optical system EO1 comprises at least one lens. In the third direction Z, the first enlargement optical system EO1 faces the second optical element 20 across the transparent substrate 1 and is located between a screen SCR1 indicated by one-dot chain line and the transparent substrate 1. This first enlargement optical system EO1 has a function of enlarging the first display light DL1 and projecting it onto the screen SCR1.

The second enlargement optical system EO2 comprises at least one lens. In the third direction Z, the second enlargement optical system EO2 faces the second optical element 20 and is located between a screen SCR2 indicated by one-dot chain line and the second optical element 20. This second enlargement optical system EO2 has a function of enlarging the second display light DL2 and projecting it onto the screen SCR2.

The configuration example shown in FIG. 19 achieves the same effects as those achieved by the configuration example shown in FIG. 11. Further, the first image and the second image constituted by the respective first display light DL1 and second display light DL2 can be enlarged and projected.

The first enlargement optical system EO1 and the second enlargement optical system EO2 are applicable to all of the configuration examples disclosed in the present specification.

As another technique for achieving such illustrated enlarged projection, lens function may be added to the second optical element 20, instead of adopting the first enlargement optical system EO1 and the second enlargement optical system EO2. For example, adding the lens function to the second optical element 20 based on the reflective liquid crystal optical element disclosed in JP 2021-006895 A enables the second optical element 20 to reflect circularly polarized light and enlarge images for projection on a screen.

As described above, the present embodiment can provide a display device capable of improving visibility of images in observation at both observation positions across the display device.

While certain embodiments of the present disclosure have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is

1. A display device comprising:
a transparent substrate having a first main surface and a second main surface on a side opposite to the first main surface;
a display module facing the first main surface and configured to emit first display light and second display light toward the transparent substrate;
a first optical element facing the display module across the transparent substrate, provided on the second main surface, and configured to reflect the first display light and the second display light each passed through the transparent substrate; and
a second optical element spaced apart from the first optical element, provided on the second main surface, and configured to reflect the first display light and the second display light each propagated inside the transparent substrate, wherein
the first display light and the second display light are circularly polarized in opposite directions,
each of the first optical element and the second optical element comprises:
a first liquid crystal layer containing a first cholesteric liquid crystal; and
a second liquid crystal layer overlapping the first liquid crystal layer and containing a second cholesteric liquid crystal twisted in an opposite direction to the first cholesteric liquid crystal,
the first liquid crystal layer of the second optical element is configured to reflect the first display light reflected by the first liquid crystal layer of the first optical element, toward a first observation position facing the first main surface, and
the second liquid crystal layer of the second optical element is configured to reflect the second display light reflected by the second liquid crystal layer of the first optical element, toward a second observation position facing the second main surface.

2. The display device of claim 1, wherein
the first cholesteric liquid crystal and the second cholesteric liquid crystal have same first helical pitch.

3. The display device of claim 1, wherein
the transparent substrate has a first side surface located on a side close to the first optical element, and a second side surface facing the first side surface and located on a side close to the second optical element, and
the second side surface is covered with a light absorber.

4. The display device of claim 1, wherein
in the second optical element,
the first liquid crystal layer has a first reflective surface inclined with respect to the second main surface,
the second liquid crystal layer has a second reflective surface inclined with respect to the second main surface, and
the first reflective surface and the second reflective surface are not parallel to each other.

5. The display device of claim 4, wherein
the transparent substrate has a first side surface located on a side close to the first optical element, and a second side surface facing the first side surface and located on a side close to the second optical element,
the first reflective surface is inclined such that a side close to the first side surface is located farther from the transparent substrate than a side close to the second side surface, and
the second reflective surface is inclined such that the side close to the second side surface is located farther from the transparent substrate than the side close to the first side surface.

6. The display device of claim 1, wherein
the display module comprises:
a first display module configured to emit the first display light; and
a second display module spaced apart from the first display module and configured to emit the second display light.

7. The display device of claim 6, wherein
each of the first display module and the second display module comprises:
a display element configured to display an image;
a circular polarization element facing the display element and configured to generate circularly polarized light; and
an optical system facing the circular polarization element and configured to generate collimated light.

8. The display device of claim 6, wherein
the first display module is configured to emit the first display light corresponding to a first image,
the second display module is configured to emit the second display light corresponding to a second image, and
the second image corresponds to an inverted image of the first image.

9. The display device of claim 6, wherein
the first display module is configured to emit the first display light corresponding to a first image,
the second display module is configured to emit the second display light corresponding to a second image, and
the second image corresponds to an image different from the first image.

10. The display device of claim 1, wherein
the first liquid crystal layer in the second optical element is thinner than the first liquid crystal layer in the first optical element, and
the second liquid crystal layer in the second optical element is thinner than the second liquid crystal layer in the first optical element.

11. The display device according to claim 1, wherein
each of the first optical element and the second optical element further comprises:
a third liquid crystal layer containing a third cholesteric liquid crystal;
a fourth liquid crystal layer containing a fourth cholesteric liquid crystal twisted in an opposite direction to the third cholesteric liquid crystal;
a fifth liquid crystal layer containing a fifth cholesteric liquid crystal; and
a sixth liquid crystal layer containing a sixth cholesteric liquid crystal twisted in an opposite direction to the fifth cholesteric liquid crystal, wherein
the first cholesteric liquid crystal and the second cholesteric liquid crystal have same first helical pitch,
the third cholesteric liquid crystal and the fourth cholesteric liquid crystal have same second helical pitch,
the fifth cholesteric liquid crystal and the sixth cholesteric liquid crystal have same third helical pitch,
the first helical pitch, the second helical pitch, and the third helical pitch differ from each other, and
each of the first optical element and the second optical element is a stacked layer body of the first liquid crystal layer, the second liquid crystal layer, the third liquid crystal layer, the fourth liquid crystal layer, the fifth liquid crystal layer, and the sixth liquid crystal layer.

12. The display device of claim 11, wherein
the first cholesteric liquid crystal, the third cholesteric liquid crystal, and the fifth cholesteric liquid crystal are twisted in same direction, and
the second cholesteric liquid crystal, the fourth cholesteric liquid crystal, and the sixth cholesteric liquid crystal are twisted in same direction.

13. The display device of claim 11, wherein
each of the first display light and the second display light includes:
light in a first wavelength range,
light in a second wavelength range longer than the first wavelength range, and
light in a third wavelength range longer than the second wavelength range,
the first liquid crystal layer and the second liquid crystal layer are configured to reflect light in the first wavelength range,
the third liquid crystal layer and the fourth liquid crystal layer are configured to reflect light in the second wavelength range, and
the fifth liquid crystal layer and the sixth liquid crystal layer are configured to reflect light in the third wavelength range.

14. The display device of claim 13, wherein
each of the first liquid crystal layer, the third liquid crystal layer, and the fifth liquid crystal layer in the second optical element is configured to reflect the first display light toward the first observation position, and
each of the second liquid crystal layer, the fourth liquid crystal layer, and the sixth liquid crystal layer in the second optical element is configured to reflect the second display light toward the second observation position.

15. The display device of claim 1, wherein
the display module is a single display module configured to emit the first display light and the second display light.

16. The display device of claim 1, wherein
the display module comprises:
a display element configured to display an image and comprising a first pixel group and a second pixel group;
a first circular polarization element overlapping the first pixel group and configured to generate the first display light;
a second circular polarization element overlapping the second pixel group and configured to generate the second display light; and
an optical system facing the display element and configured to generate collimated light.

17. The display device of claim 1, further comprising:
a first polarization-control element facing the second optical element across the transparent substrate, provided on the first main surface, and configured to transmit the first display light and absorb the second display light; and
a second polarization-control element overlapping the second optical element and configured to transmit the second display light and absorb the first display light.
